(19) United States
(12) Patent Application Publication
(10) Pub. No.: US 2023/0316408 A1
(43) Pub. Date: Oct. 5, 2023

(54) ARTIFICIAL INTELLIGENCE (AI)-ENABLED HEALTHCARE AND DENTAL CLAIM ATTACHMENT ADVISOR

(71) Applicant: Change Healthcare Holdings, LLC, Nashville, TN (US)

(72) Inventors: Sajid Khan, Brentwood, TN (US); Prativa Behera, Mississauga (CA)

(21) Appl. No.: 17/710,235

(22) Filed: Mar. 31, 2022

(51) Int. Cl. G06Q 40/08

(52) U.S. Cl. CPC G06Q 40/08

(57) ABSTRACT

An example claim processing system and method are disclosed that employ analytics (e.g., machine-learning analytics) and artificial intelligence operations to evaluate a healthcare claim (medical, dental, or vision) with attachments and determine a likelihood of payment of the claim by a payer. In some embodiments, the example claim system and method may be implemented by a third-party service provider that serves as an intermediary entity between a service provider and a payer to provide claim processing analytics to the payer. In other embodiments, the example system and method may be implemented by a payer within its internal evaluation processes to improve its efficiency and workflow.

### FIELD OF THE INVENTION

Embodiments of the present invention relate generally to systems and methods of computer-aided review and verification of healthcare images and other attachments associated with healthcare claims. Such review can be used to develop a quantitative score for each claim and associated attachments. The quantitative score is compared to a payer specific threshold and further actions on the claim and associated attachment are taken based on the comparison and payer-specific rules. In some instances, the quantitative score comprises a likelihood of the payer paying the claim. In some instances, the payer-specific rules may require that the quantitative score exceeds a threshold before the claim is forwarded to the payer for adjudication. In some instances, review and verification of medical images and other attachments associated with the healthcare claims, as well as determination of the quantitative score is performed using one or more artificial intelligence (“AI”) trained software engines. Typically, the one or more AI engines are trained using machine learning (“ML”) analysis of historical claims, attachments and payer responses to the claims and attachments.

### BACKGROUND

There is a commercial benefit to automating and streamlining the review and approval process for healthcare (medical, dental, or vision) claims. In a typical claim processing workflow for healthcare services (medical, dental, and vision), following providing a service to a patient, a service provider would submit a healthcare claim (medical, dental, or vision claim) on behalf of a patient to a payer (e.g., a patient's insurance company) for reimbursement. The payer would evaluate the claim and either approve the claim, in whole or in part, reject the claim, or request for additional information. With many claim types, the payer would require the service provider to submit supporting evidence of the service being performed and the necessity of that treatment and would then evaluate that information and the claim request in view of the patient's insurance policy (medical, dental, or vision). The task is often non-trivial, i.e., time-consuming, and employs a substantial degree of human judgment, namely, to evaluate the validity of a claim and whether the evidentiary support for the claim is sufficient. The payer may also evaluate for fraud or mistakes in the process.

The approval process can be highly complex. Each procedure may require a different set of evidence, often in the form of medical scans or images, prior to and following a procedure, or annotations or notes from the clinician of the same. The evaluation of medical scans or images and/or annotations is highly technical, requiring a clinical understanding of the provided services. The cost of the reimbursement is also non-trivial, so the evaluation has to be highly accurate and consistent. For many claims, if the claim is rejected, the payer is required to provide an explanation for the rejection.

For example, adjudication of insurance claims for many dental procedures typically requires the attachment of supporting radiographs, intraoral camera pictures, and the like to have the claim accepted. These images, and associated claims, are typically submitted electronically from the provider to a third-party service (e.g., a “clearinghouse”) for delivery to the payer. Currently, the payers' claims adjudicators, most of whom are neither radiologists nor dentists, are expected to examine the images to make sure that they properly document the claim. The adjudicator should have the skill and training to determine, for example, that a radiograph of the patient's left molars do not support a claim submitted for a three-surface restoration on an upper-right molar. However, the adjudicator is unlikely to have the skill to note that there was no sign of distal decay on a correct radiograph. Discrepancies between claim verbiage and attached images may result in undetected up-coding (claims requesting payment for procedures that may not have actually been performed by the provider and are not shown in the images, or claims requesting payment for more expensive procedures than what are shown in the images), thus increasing costs to payers.

In light of the foregoing, payers will utilize radiologists, dentists, or other skilled reviewers, to assist in the review of certain claims and their supporting evidence (i.e., medical images). However, close examination of radiographs is time-intensive and the types of claims that receive detailed review by a radiologist, dentist, or other skilled reviewer, must be prioritized. For example, only about 25% of claims for multi-surface restorations are reviewed at all and thus payers (or the patients themselves) frequently overpay for this procedure. In certain circumstances, a payer will refer claims to a recovery audit contractor (RAC) to perform a thorough audit of one or more claims submitted by a provider. However, the RAC typically is paid a percentage of the claims that are identified as being unjustified. This is a time-consuming and expensive process.

Embodiments described herein address the shortcomings of medical (e.g., dental) imaging, detection and diagnosis, and related claims processing described above.

### BRIEF SUMMARY

An example claim processing system and method are disclosed that employ analytics and artificial intelligence operations, employing an AI-driven model, to evaluate a healthcare claim (medical, dental, or vision) and to perform a clinical evaluation of the claim. As noted above, payers often employ highly skilled radiologists and specialists to determine the validity of attachments for an associated claim. The rules for adjudication and attachment verification can vary from payer to payer. The claim processing engine and corresponding platform can also evaluate the claim for fraudulent and non-fraudulent duplicates.

The disclosed claim processing system and method can automate the clinical review of healthcare (medical and/or dental) claims with attachments and provide a scoring for the claim that is based on a likelihood that the claim would be approved by a payor based on the corresponding attachments. The score can be used to recommend approval of a certain set of claims to the payer at a level of confidence, so that the payer can optionally remit payment to the healthcare claim request without the attachments having to be reviewed (substantively via manual review) by the payer. In addition to improving the approval time, reducing the cost of the clinical review process, the transmission and storage need at the payers' end, the claim processing engine and corresponding platform can improve the consistency of claim review in providing the same action for similar attachments and claims.

In some instances, the example claim processing system and method may be implemented by a third-party service provider that serves as an intermediary entity between a service provider and a payer to provide claim processing analytics to the payer. In other embodiments, the example claim processing system and method may be implemented by a payer within its internal evaluation processes to improve its efficiency and workflow.

In some instances, the example claim processing system and method are configured to employ a decision matrix having a plurality of rules established by a set of fields, including a claim type field or parameter, a field or parameter associated with required medical images or scans as attachments, and a payer's historical payment history, to generate a score associated with a likelihood of payment. The payer can adjust a threshold to which the score is evaluated. The system can assist a payer in reviewing common claims (that are nevertheless technically non-trivial to evaluate) that are most often submitted by a service provider, the system's review reducing the frequency of rejections and freeing resources (e.g., evaluators) that would otherwise be employed in the evaluation of such claims to focus on more complex or non-standard claims.

In one aspect, a system for evaluating a healthcare claim is disclosed. Such a system may comprise at least one computing device comprising a processor and a memory. The memory has instructions stored thereon that when executed by the processor cause the at least one computing device to perform a plurality of operations. The plurality of operations may include receiving, by the processor, a healthcare claim fora healthcare service performed by a healthcare service provider, the healthcare claim comprising (i) a claim request listing one or more services provided by the healthcare service provider for a patient and (ii) one or more image files, and/or metadata descriptions thereof, corresponding to the one or more services; determining, by the processor, at least one score indicating a likelihood of approval of the healthcare claim by a payer based on an analysis of the one or more image files and/or the metadata descriptions thereof; comparing, by the processor, the determined at least one score to a threshold value associated with the payer to create a recommendation, wherein if the at least one score is equal to or greater than the threshold value, then the recommendation is to approve the healthcare claim for payment, and if the at least one score is less than the threshold value, then the recommendation is to not approve the healthcare claim for payment; and transmitting at least a portion of the healthcare claim to the payer.

In some instances of the system, the at least one score for the healthcare claim may be determined by an AI/ML engine/model trained with past healthcare claims and decision history data of the payer associated with the past healthcare claims. For example, the at least one score comprises a first score associated with a set of factors comprising quality, image type, duplication, and match of what's in the healthcare claim. The first score is based on separate scores/probabilities for each of the set of factors as determined by individual respective AI/ML engines/models trained with past healthcare claims and decision history data of the payer associated with the past healthcare claims. The quality factor may be determined by its respective AI/ML engine/model predicting a probability that the one or more image files of the healthcare claim are of sufficient quality The image type factor may be determined by its respective AI/ML engine/model predicting a probability that the one or more image files of the healthcare claim are of a specific types that match a procedural code in the claim request. The duplication factor may be determined by its respective AI/ML engine/model predicting a probability that the one or more image files are or are not duplicate images from another healthcare claim. And, the match of what's in the healthcare claim factor may be determined by its respective AI/ML engine/model predicting a probability, for a dental claim, that a tooth/procedure identified in the one or more image files and/or metadata description is a same tooth/procedure identified in the healthcare claim request.

In some instances of the system, the at least one score may comprise a plurality of scores, each of the plurality of scores may be determined by a respective AI/ML engine/model trained with past healthcare claims and decision history data of the payer associated with the past healthcare claims. The plurality of scores may further comprise a second score and a third score, where the second score is associated with medical necessity, and comprises a probability that a medical condition satisfies a need to perform a procedure included in the healthcare claim. The third score may be associated with natural language processing of a narrative of the healthcare claim, comprising a probability that a procedure described in the narrative of the healthcare claim matches with the one or more image files, metadata description, and/or claim request of the healthcare claim. In such instances, the comparing, by the processor, the determined at least one score to a threshold value associated with the payer comprises comparing the first score, the second score and the third score to a plurality of threshold values associated with the payer that comprise a decision matrix and making the recommendation for the payer based on the comparison using the decision matrix.

In some instances of the system, transmitting at least the portion of the healthcare claim to the payer comprises transmitting only the claim request to the payer, wherein the claim request is accompanied by the recommendation. For example, the recommendation may be the recommendation to approve payment of the healthcare claim.

In some instances of the system, the claim request transmitted to the payer with the recommendation may further comprise a link to the one or more image files.

In some instances of the system, transmitting at least the portion of the healthcare claim to the payer may comprise transmitting the claim request and the one or more image files, and/or metadata descriptions thereof to the payer without the recommendation.

Another aspect disclosed herein is a computer-implemented method for evaluating a healthcare claim. Such a method may comprise receiving, by a processor, a healthcare claim for a healthcare service performed by a healthcare service provider, the healthcare claim comprising (i) a claim request listing one or more services provided by the healthcare service provider for a patient and (ii) one or more image files, and/or metadata descriptions thereof, corresponding to the one or more services; determining, by the processor, at least one score indicating a likelihood of approval of the healthcare claim by a payer based on an analysis of the one or more image files and/or the metadata descriptions thereof, wherein the at least one score for the healthcare claim is determined by an AI/ML engine/model trained with past healthcare claims and decision history data of the payer associated with the past healthcare claims; comparing, by the processor, the determined at least one score to a threshold value associated with the payer to create a recommendation, wherein if the at least one score is equal to or greater than the threshold value, then the recommendation is to approve the healthcare claim for payment, and if the at least one score is less than the threshold value, then the recommendation is to not approve the healthcare claim for payment; and transmitting at least a portion of the healthcare claim to the payer.

In some instances of the method, the at least one score comprises a first score associated with a set of factors comprising quality, image type, duplication, and match of what's in the healthcare claim, wherein the first score is based on separate scores/probabilities for each of the set of factors, as determined by individual respective AI/ML engines/models trained with past healthcare claims and decision history data of the payer associated with the past healthcare claims. For example, the quality factor may be determined by its respective AI/ML engine/model predicting a probability that the one or more image files of the healthcare claim are of sufficient quality. The image type factor may be determined by its respective AI/ML engine/model predicting a probability that the one or more image files of the healthcare claim are of a specific types that match a procedural code in the claim request. The duplication factor may be determined by its respective AI/ML engine/model predicting a probability that the one or more image files are or are not duplicate images from another healthcare claim. And, the match of what's in the healthcare claim factor may be determined by its respective AI/ML engine/model predicting a probability, for a dental claim, that a tooth/procedure identified in the one or more image files and/or metadata description is a same tooth/procedure identified in the healthcare claim request.

In some instances of the method, the at least one score comprises a plurality of scores, each of the plurality of scores determined by a respective AI/ML engine/model trained with past healthcare claims and decision history data of the payer associated with the past healthcare claims. For example, the plurality of scores may further comprise a second score and a third score. The second score may be associated with medical necessity, comprising a probability that a medical condition satisfies a need to perform a procedure included in the healthcare claim. The third score may be associated with natural language processing of a narrative of the healthcare claim, comprising a probability that a procedure described in the narrative of the healthcare claim matches with the one or more image files, metadata description, and/or claim request of the healthcare claim. In such instances, the comparing, by the processor, the determined at least one score to a threshold value associated with the payer comprises comparing the first score, the second score and the third score to a plurality of threshold values associated with the payer that comprise a decision matrix and making the recommendation for the payer based on the comparison using the decision matrix.

In some instances of the method, transmitting at least the portion of the healthcare claim to the payer comprises transmitting only the claim request to the payer, wherein the claim request is accompanied by the recommendation. For example, the recommendation may be the recommendation to approve payment of the healthcare claim.

In some instances of the method, the claim request transmitted to the payer with the recommendation may further comprise a link to the one or more image files.

In some instances, transmitting at least the portion of the healthcare claim to the payer comprises transmitting the claim request and the one or more image files, and/or metadata descriptions thereof to the payer without the recommendation.

In yet another aspect, a non-transitory computer-readable medium having instructions stored thereon that when executed by at least one computing device cause the at least one computing device to perform a plurality of operations for evaluating a healthcare claim is disclosed. The plurality of operations may include receiving, by a processor of the computing device, a healthcare claim for a healthcare service performed by a healthcare service provider, the healthcare claim comprising (i) a claim request listing one or more services provided by the healthcare service provider for a patient and (ii) one or more image files, and/or metadata descriptions thereof, corresponding to the one or more services; determining, by the processor, at least one score indicating a likelihood of approval of the healthcare claim by a payer based on an analysis of the one or more image files and/or the metadata descriptions thereof, wherein the at least one score for the healthcare claim is determined by an AI/ML engine/model trained with past healthcare claims and decision history data of the payer associated with the past healthcare claims; comparing, by the processor, the determined at least one score to a threshold value associated with the payer to create a recommendation, wherein if the at least one score is equal to or greater than the threshold value, then the recommendation is to approve the healthcare claim for payment, and if the at least one score is less than the threshold value, then the recommendation is to not approve the healthcare claim for payment; and transmitting at least a portion of the healthcare claim to the payer.

In some instances of the computer-readable medium, the at least one score comprises a plurality of scores, each of the plurality of scores is determined by a respective AI/ML engine/model trained with past healthcare claims and decision history data of the payer associated with the past healthcare claims, wherein the plurality of scores comprise a first score set, said first score set associated with a set of factors comprising quality, image type, duplication, and match of what's in the healthcare claim, wherein the first score is based on separate scores/probabilities for each of the first score set, as determined by individual respective AI/ML engines/models. In such instances, the quality factor may be determined by its respective AI/ML engine/model predicting a probability that the one or more image files of the healthcare claim are of sufficient quality. The image type factor may be determined by its respective AI/ML engine/model predicting a probability that the one or more image files of the healthcare claim are of a specific types that match a procedural code in the claim request. The duplication factor may be determined by its respective AI/ML engine/model predicting a probability that the one or more image files are or are not duplicate images from another healthcare claim. And, the match of what's in the healthcare claim factor may be determined by its respective AI/ML engine/model predicting a probability, for a dental claim, that a tooth/procedure identified in the one or more image files and/or metadata description is a same tooth/procedure identified in the healthcare claim request.

In some instances of the computer-readable medium, the plurality of scores may further comprise a second score and a third score. The second score may be associated with medical necessity, comprising a probability that a medical condition satisfies a need to perform a procedure included in the healthcare claim. The third score may be associated with natural language processing of a narrative of the healthcare claim, comprising a probability that a procedure described in the narrative of the healthcare claim matches with the one or more image files, metadata description, and/or claim request of the healthcare claim. In such instances, the comparing, by the processor, the determined at least one score to a threshold value associated with the payer may comprise comparing the first score, the second score and the third score to a plurality of threshold values associated with the payer that comprise a decision matrix and making the recommendation for the payer based on the comparison using the decision matrix.

In some instances of the computer-readable medium, transmitting at least the portion of the healthcare claim to the payer may comprise transmitting only the claim request to the payer, wherein the claim request is accompanied by the recommendation. For example, the recommendation may be the recommendation to approve payment of the healthcare claim.

In some instances of the computer-readable medium, claim request transmitted to the payer with the recommendation may further comprise a link to the one or more image files. In yet other instances, transmitting at least the portion of the healthcare claim to the payer may comprise transmitting the claim request and the one or more image files, and/or metadata descriptions thereof to the payer without the recommendation.

Other objects and advantages will become apparent to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1A. Illustrates an exemplary overview system for performing aspects of the disclosed embodiments.

FIG. 1B is an illustration of the system of FIG. 1A further comprising an AI-enabled Attachment Advisor Service that analyzes the claims and attachments and predicts whether a payer is likely to approve the claim based on an analysis of the one or more attachments and payer-specific rules.

FIG. 1C is a more-detailed exemplary illustration of the AI-enabled Attachment Advisor Service comprising one or more computer-implemented artificial intelligence-enabled AI/ML engines/models.

FIG. 1D is an even more-detailed illustration of the system shown in FIGS. 1B and 1C.

FIG. 2 is a flowchart illustrating an exemplary method of operating the Attachment Advisor Service in accordance with an illustrative embodiment.

FIGS. 3A and 3B show an example Attachment Advisor Processing Engine and Attachment Advisor System of the Attachment Advisor Service 118 in accordance with illustrative embodiments.

FIG. 4 shows an example image processing pipeline and workflow of the Attachment Advisor Service working cooperatively with a clearinghouse in accordance with an illustrative embodiment.

FIG. 5 illustrates a non-exhaustive list of examples of clinical estimations that may be generated by the AI-data model of FIG. 4.

FIG. 6 shows an example computing environment in which example embodiments and aspects may be implemented.

### DETAILED DESCRIPTION

Before the present methods and systems are disclosed and described, it is to be understood that the methods and systems are not limited to specific synthetic methods, specific components, or to particular compositions. It is also to be understood that the terminology used in this entire application is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, to “about” another particular value, or from “about” one value to “about” another value. When such a range is expressed, another embodiment includes from the one particular value, to the other particular value, or from the one particular value to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. “Exemplary” means “an example of” and is not intended to convey an indication of a preferred or ideal embodiment. “Such as” is not used in a restrictive sense, but for explanatory purposes.

In this document, the terms “X-ray” and “radiograph” are used interchangeably. Strictly speaking, a radiograph is the image of a person's anatomy as acquired by an X-ray imaging system. The particular modality referenced in the preferred embodiment is bite-wing radiographs acquired by computed- or digital radiography systems. Nonetheless, the embodiments for dental applications may be used on digitized film radiographs, panoramic radiographs, and cephalometric radiographs. The general medical imaging application of the embodiment can utilize radiographs and other sources of medical images, such as MRI, CT, ultrasound, PET, and SPECT machines.

When referring to the image-related information that a provider attaches to a claim, the plural form of “X-ray” or “image” will be used for brevity instead of stating “one or more X-rays” or “one or more images.” In practice, a provider may attach more than one X-ray image files to support the claim.

Use of the word “claim” follows the same style as “X-ray,” as it is possible for multiple claims to be submitted, for example, to a primary and secondary insurer.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, DVD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present methods and systems may be understood more readily by reference to the following detailed description of preferred embodiments and the Examples included therein and to the Figures and their previous and following description.

### Overview

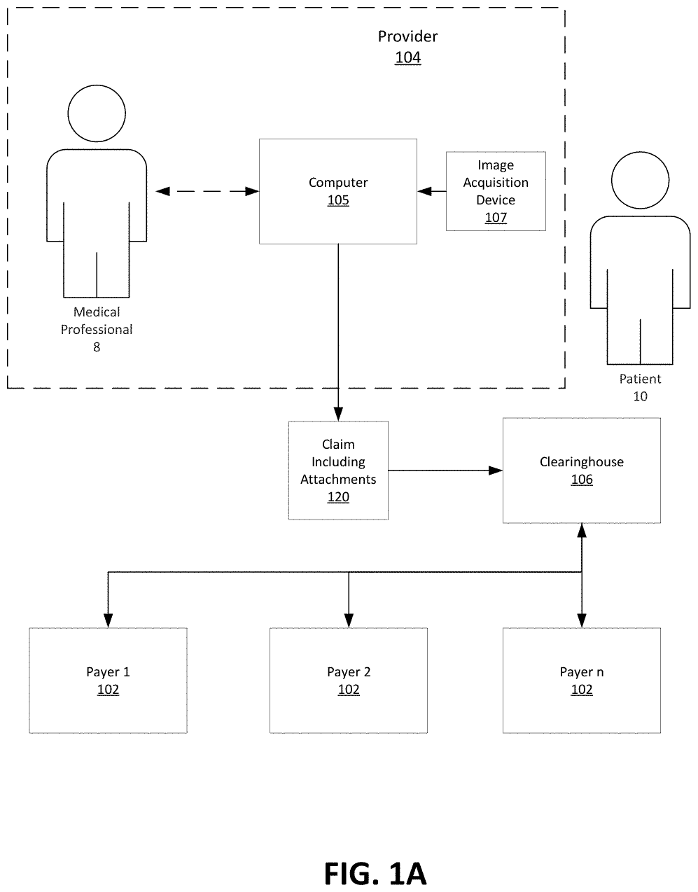

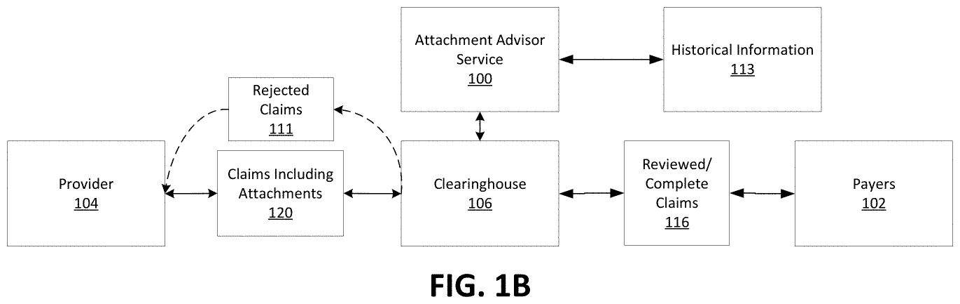

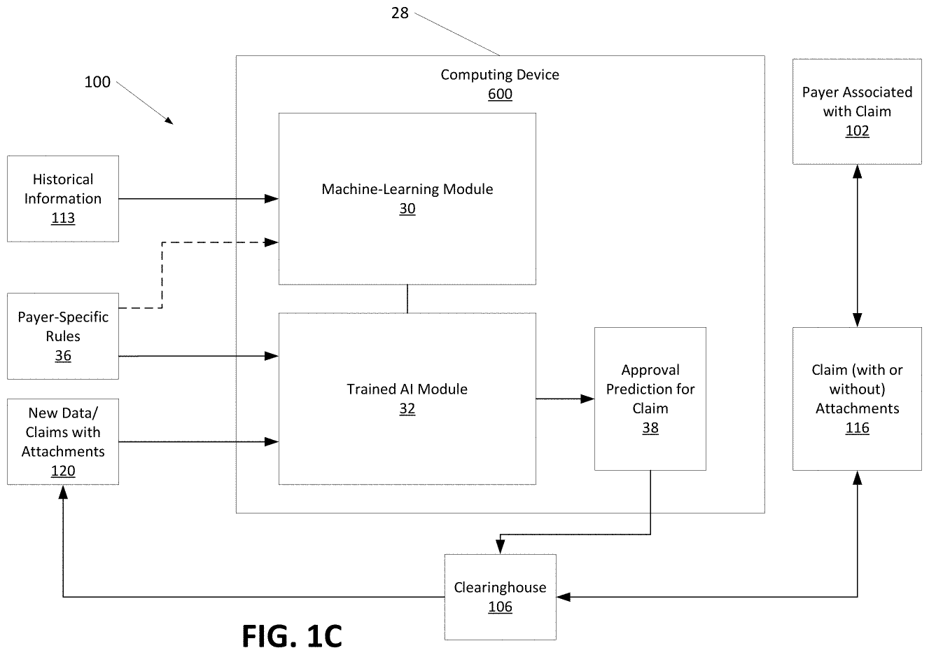

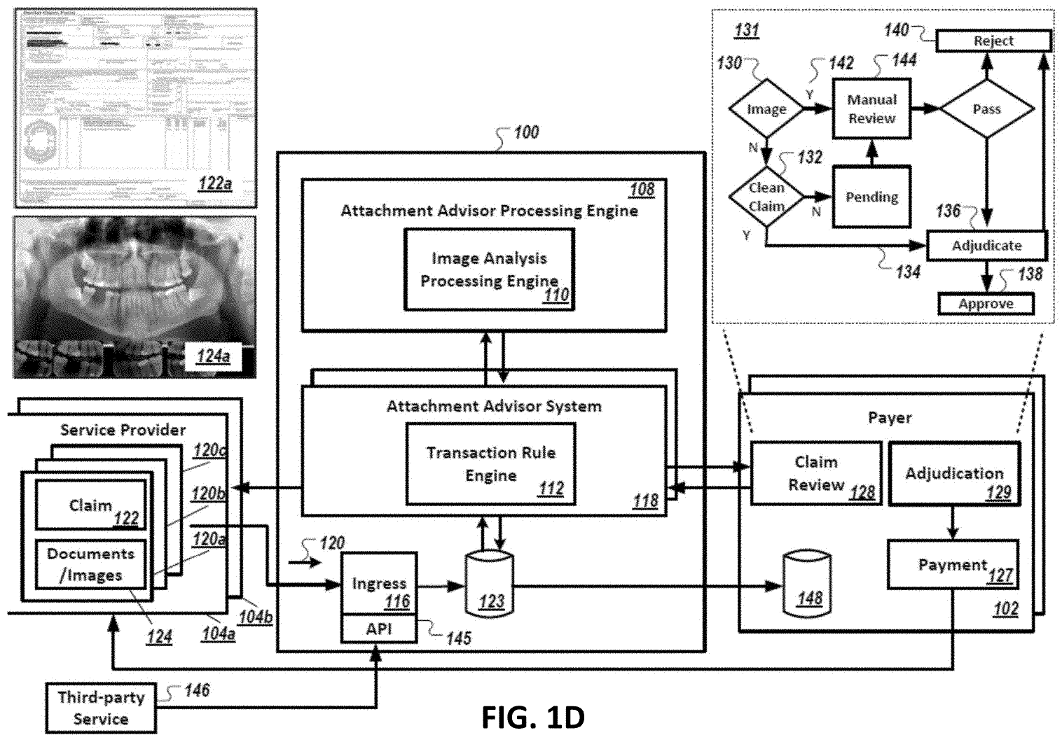

FIG. 1A Illustrates an exemplary overview system for performing aspects of the disclosed embodiments. In FIG. 1A, an image of a pathology of a patient 10 is acquired by an image acquisition device 107 such as an X-ray, MRI, CT, ultrasound, PET, SPECT machine, and the like. The acquired one or more images are then transferred to a computer 105. In some instances, the image acquisition device 107 may be directly connected to the computer 105, while in other instances the images may be acquired by the image capture device 107 and then transferred (e.g., manually, or electronically) to the computer 105.

Once received by the computer 105, a claim 120 is developed for work performed by the medical professional/provider 8, and generally the claim 120 is comprised of two portions: (1) diagnosis/diagnostics, treatment and billing information (collectively referred to herein as “written information,” which includes electronically entered, transferred and/or transmitted information) and (2) the one or more images. The claim 120 is typically transmitted from the provider 104 to a clearinghouse 106. The clearinghouse 106 may receive hundreds or thousands of claims and associated images 120 each day from a large number of providers 104 and/or groups of providers 104. The clearinghouse 106, in turn, prepares the claims and attachments 120 for adjudication by one or more payers 102.

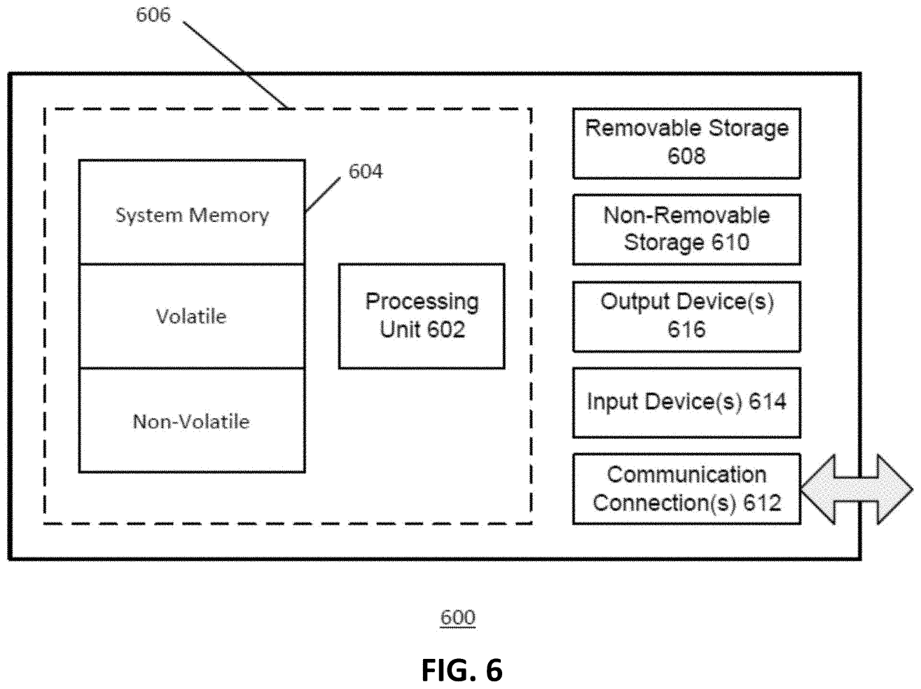

FIG. 1B is an illustration of the above described system further comprising an AI-enabled Attachment Advisor Service 100 that analyzes the claims and attachments 120 and predicts whether a payer 102 is likely to approve the claim 120 based on an analysis of the one or more attachments and payer-specific rules. The Attachment Advisor Service 100 utilizes a plurality of AI-enabled engines to analyze the claims and attachments 120 and make the predictions. The AI-enabled engines are trained using historical information 113 from past claims, attachments, and past responses (e.g., approved, deny, require additional work, etc.) of payers 102 to the claims and attachments. The AI-enabled Attachment Advisor Service 100 may be implemented using one or more general purpose computing devices such as the computing device 600 illustrated in FIG. 6.

In FIG. 1B, claims 120 are generated by a provider or number of providers 104, as described in relation to FIG. 1A. In some instances, claims 120 may be created by several, unrelated providers 104. In other instances, the claims 120 may be for a singular provider 104 or for a group of related providers 104. For example, these claims 120 may be insurance claims or requests for payment for healthcare services rendered by the provider 104. In this light, a provider 104 may be a physician, technician, nurse, healthcare worker, medical professional, dentist, orthodontist, and the like. As noted above, the claim 120 comprises a written portion and one or more images or other attachments. The claims 120 are forwarded to the clearinghouse 106. Generally, the claims, including attachments 120 are electronically transmitted over a network to the clearinghouse 106 in a standard electronic format (e.g., in the United States this may be the ANSI ASC X12N 837 format, incorporated by reference), though equivalents and other such formats are contemplated within the scope of this disclosure. The clearinghouse 106 receives the claims 120 from the providers 104 and reviews them for completeness, accuracy, containing the correct codes (e.g., Current Procedural Terminology (CPT™) codes) for the services/procedures performed by the provider 104, and the like. Incomplete claims and/or claims that appear to be incorrect (i.e., rejected claims 111) are typically automatically and electronically returned to the provider 104 to be corrected and re-submitted. Conventionally, complete, and accurate claims 116 are forwarded on to a payer 102 (e.g., an insurance company, a governmental entity, and the like). Just as the clearinghouse may work with a plurality of providers 104, it generally also works with a plurality of payers 102. The payer 102 pays the provider 104 for the claim in accordance with an agreement between the provider 104 and the payer 102. Generally, the claims review by the clearinghouse 106 is a computer-implemented process that is performed automatically and with very little manual intervention. Conventionally, the clearinghouse 106 does not conduct any sort of in-depth review or analysis of the claims 120. It only ensures the written description of the claim 120 is associated with one or more attachments, and forwards the claim to the respective payer 102 associated with the claim. Conventionally, payers 102 use highly skilled radiologists to determine the validity of the attachments for the associated claims. The rules for the adjudication and the attachment verification varies from payer to payer. This is an expensive solution and the turnaround time on claim payments to provider is higher. There is an industry wastage due to the transmission, storage, and manual intervention of attachments.

Therefore, as shown in FIG. 1B, claims 120 may be reviewed and analyzed by the disclosed AI-enabled Attachment Advisor Service 100. As described herein, the AI-enabled Attachment Advisor Service 100 analyzes the written description of the claims as compared to the one or more associated attachments and predicts whether a payer 102 associated with the claim 120 is likely to approve the claim 120 based on the analysis and payer-specific rules.

As shown in FIG. 1C, the AI-enabled Attachment Advisor Service 100 comprises one or more computer-implemented artificial intelligence-enabled AI/ML engines/models 28. Each AI/ML engine/model is comprised of at least a machine-learning module 30 and a trained AI module 32. The term “artificial intelligence” is defined herein to include any technique that enables one or more computing devices or computing systems (i.e., a machine) to mimic human intelligence. AI includes, but is not limited to, knowledge bases, machine-learning, representation learning, and deep learning. The term “machine-learning” is defined herein to be a subset of AI that enables a machine to acquire knowledge by extracting patterns from raw data. Machine-learning techniques include, but are not limited to, logistic regression, support vector machines (SVMs), decision trees (including randomized decision forests), Naïve Bayes classifiers, AutoRegressive Integrated Moving Average (ARIMA) machine-learning algorithms, and artificial neural networks. The term “representation learning” is defined herein to be a subset of machine-learning that enables a machine to automatically discover representations needed for feature detection, prediction, or classification from raw data. Representation learning techniques include, but are not limited to, autoencoders. The term “deep learning” is defined herein to be a subset of machine-learning that that enables a machine to automatically discover representations needed for feature detection, prediction, classification, etc. using layers of processing. Deep learning techniques include, but are not limited to, artificial neural network (including deep nets, long short-term memory (LSTM) recurrent neural network (RNN) architecture), or multilayer perceptron (MLP). Machine-learning models include supervised, semi-supervised, and unsupervised learning models. In a supervised learning model, the model learns a function that maps an input (also known as feature or features) to an output (also known as target or target) during training with a labeled data set (or dataset). In an unsupervised learning model, the model learns a function that maps an input (also known as feature or features) to an output during training with an unlabeled data set. In a semi-supervised model, the model learns a function that maps an input (also known as feature or features) to an output (also known as target or target) during training with both labeled and unlabeled data.

The AI/ML engine/model 28 comprises AI that has been trained to analyze and review claims with attachments 120, and generate a quantitative assessment (i.e., one or more “scores”) of the claim 120, which is used to predict 38 whether the payer 102 associated with the claim 120 will approve (or not approve) the claim 120 based on payer-specific rules 36.

As shown in FIG. 1C, each AI/ML engine/model 28 may include both a machine-learning (e.g., training) module 30 and a trained AI module 32 used for processing new data on which to make event predictions. The training module 30 uses training data, which may comprise historical information associated with past claims (including their written portions and attachments (e.g., images)), and feedback from payers 102 associated with those past claims. Generally, the feedback will comprise whether the payer 102 approved the past claims for payment, or not, or any other action taken by the payer 102 on the past claim. Therefore, the training data may comprise information associated with healthcare claims (including attachments) 120 for services provided to one or more patients, information associated with the one or more providers 104 that provided services to the one or more patients, and information associated with the payers 102 of the healthcare claims. Generally, the training data is at least partially comprised of historical data extracted from past claims and the corresponding dispensation of those claims by the payer 102. The training data may also include exemplary payer-specific rules, as described herein. The machine-learning module 30 is further configured to identify the individual independent variables that are used by the trained AI module 32 to make predictions, which may be considered a dependent variable. For example, the training data may be generally unprocessed or formatted and include extra information in addition to medical claim information, provider information, and payer information. For example, the medical claim data may include account codes, codes associated with the services performed by the provider, business address information, and the like, which can be pre-processed by the machine-learning module 30. The features extracted from the training data may be called attributes and the number of features may be called the dimension. The machine-learning module 30 may further be configured to assign defined labels to the training data and to the generated predictions to ensure a consistent naming convention for both the input features and the predicted outputs. The machine-learning module 30 processes both the featured training data, including the labels, and may be configured to test numerous functions to establish a quantitative relationship between the featured and labeled input data and the predicted outputs. The machine-learning module may use modeling techniques, as described herein, to evaluate the effects of various input data features on the predicted outputs. These effects may then be used to tune and refine the quantitative relationship between the featured and labeled input data and the predicted outputs. The tuned and refined quantitative relationship between the featured and labeled input data generated by the machine-learning module 30 is outputted for use in the trained AI module 32. The machine-learning module 30 may be referred to as a machine-learning algorithm.

The trained AI module 32 is used for processing new data on which to make event predictions using the new data 120 (e.g., data from the claims for review, with attachments) based on training by the training module 30. The new data 120 may be the same data/information as the training data in content and form except the new data will be used for an actual event forecast or prediction, e.g., a prediction of a whether a specific payer 102 associated with the claim 120 will approve the claim 120 for payment, in accordance with the payer-specific rules 36. The new data 120 can also have different content and form from the prior training data and still nevertheless can be evaluated by the trained AI module 32 to generate a prediction of a whether a specific payer 102 associated with the claim 120 will approve the claim 120 for payment, in accordance with the payer-specific rules 36. The term “prediction” refers not to a forecast of a future event, but a determined likelihood from an associated training in the machine learning algorithm that correlates an algorithm observed pattern with an outcome.

The trained AI module 32 may, in effect, be generated by the machine-learning module 30 in the form of the quantitative relationship determined between the featured and labeled input data and the predicted outputs. The trained AI module 32 may, in some embodiments, be referred to as an AI model. The trained AI module 32 may be configured to output predicted events 38, as described herein. The predicted events 38 may be used by the clearinghouse to reject the claim (see rejected claim 111 in FIG. 1B), to transmit the claim (with or without attachments) 116 on to its associated payer 102 for adjudication and/or perform whatever action is requested by the payer 102 in accordance with the payer-specific rules. As examples, such payer-specific rules may include send the claim (or apportion of it) with an indication of likely approval and no image, send the claim (or apportion of it) with an indication of and an image, send the claim (or apportion of it) without any kind of an indication of anything (and without any image), or don't send the claim (or any portion of it at all) (i.e., reject on the payer's behalf). Claims transmitted to the payer 102 may include a recommendation to approve the claim, a recommendation to not approve the claim, or there may not be an associated recommendation. The trained AI module 32 may be configured to communicate the event prediction 38 in a variety of formats and may include additional information, including, but not limited to, illustrations of the event in comparisons to an idealized version of the event, comparison of the event outcome relative to one or more of the featured inputs, and trends in the event outcomes including a breakdown of such trends relative to one or more of the featured inputs. In some embodiments, the predicted events 38 are generated based on stimulus, such as claim information, provider information, payer information, and/or payer-specific rules 36. The trained AI module 32 may be continually or periodically re-trained by the machine-learning module 30 as new data is received into the historical information 113 and accessed by the machine-learning module 30.

FIG. 1D is a more-detailed illustration of the system shown in FIGS. 1B and 1C. FIG. 1D shows an example environment comprising an Attachment Advisor Service 100 configured with an analytics and artificial intelligence engine to evaluate a healthcare claim on behalf of a payer 102 (shown as 102a, 102b) in accordance with an illustrative embodiment. In the example shown in FIG. 1D, the Attachment Advisor Service 100 is implemented as a third-party service provider that serves as an intermediary entity between (i) a service provider 104 (shown as 104a, 104b) that provides health services to patients 106 (not shown) and (ii) the payer 102 to provide claim processing analytics to the payer 102, e.g., in the form of an attachment advisor.

In the example shown in FIG. 1D, the Attachment Advisor Service 100 includes an Attachment Advisor Processing Engine 108 comprising one or more Image Analysis Processing Engines 110 that each have one or more AI/ML model/engines. The Attachment Advisor Processing Engine 108 operates with an Attachment Advisor System 118 comprising a Transaction Rule Engine 112. Each Image Analysis Processing Engine 110 can evaluate image files of an attachment for metrics associated with image quality, image duplication, image type, claim consistency for the procedural codes in a given claim 120, and the like, to provide one or more scores that are each determined by the one or more AI/ML models/engines. Typically, the scores represent a likelihood of a payer 102, associated with a claim 104, accepting the claim 104 based on the provided attachments. The Transaction Rule Engine 112 compares the score(s) to threshold value(s) provided by the payer (payer-specific rules) 102 to provide an indication (e.g., pre-defined message, codes, or the like) of a recommendation to approve remittance of the claim document, e.g., upon the system determining at least one score exceeding a corresponding threshold value. It should be appreciated that all of the steps of evaluating the images for metrics like quality, duplication, image type, matching, etc., may be performed by a combination of AI and business logic or a combined model/module thereof. The Attachment Advisor Processing Engine 108 may be configured as a pipeline operation that is performed for each set of received medical images. The Image Analysis Processing Engine 110 and the Transaction Rule Engine 112 may be integrated as a single module, or they can be implemented in different modules (as shown in FIG. 1D).

The Attachment Advisor Processing Engine 108, and/or its subcomponents or submodules, typically operates with an ingress module 116. The ingress module 116 is configured to receive one or more claims 120 (shown as 120a, 120b, 120c) from a service provider (e.g., 104a, 104b) and store the claims 120 in a data security (e.g., Health Insurance Portability and Accountability Act of 1996 (HIPAA))-compliant data store 123. The claims 120 can be sent individually, or may be sent in batches. In the example shown in FIG. 1D, a claim (e.g., 120a, 120b, 120c) may include a claim request or document 122 (an example dental claim request is shown as 122a) and a corresponding one or more medical claim images 124 as an attachment to the claim request 122 (an example dental image is shown as 124a). A claim request includes a claim which can have one or more associated procedural codes for treatments that have been performed. The claim can be approved in whole or in part. In some embodiments, the claim 120 may include only a claim request 122 without a corresponding medical claim image 124. The Attachment Advisor Processing Engine 108 is configured to review the claim request 122, and the attached medical claim images 124, if applicable, according to claim review rules and using an analytical pipeline to validate the claim and/or provide the claim to the payer 102 for manual processing.

As briefly noted above, the validation/review may involve, for example, using the one or more AI/ML engines/models, in combination with business rules, to (i) check for duplicate claim submissions, (ii) validate that the submitted medical claim images 124 match the required image for the submission, (iii) validate that the tooth to which a service was performed and the service performed, both as evident in the submitted images, is consistent with the information in the claim request, (iv) confirm the medical condition satisfies the necessity for the procedure, and the like. The process may further include generating a probability score associated with each of the above validation criteria based on a likelihood assessed by the respective AI/ML engine/model that the claim request and/or the corresponding medical claim image satisfy the corresponding validation criteria (e.g., 90% confident the image is of sufficient quality). As used herein, “sufficient quality” is intended to represent any metric that can be used to determine the quality of an image being at a defined or acceptable level to the payer. For example, a payer may require as a quality metric that the size of the image should be >600 KB and <20 MB. In some embodiments, the validation may further involve checking for image manipulation (e.g., manipulation of labels or image features) that may be associated with a fraudulent submission.

The Image Analysis Processing Engine 110, or its functions, is configured to provide image analysis and/or diagnostic analysis employed in the validation. In some instances, the Image Analysis Processing Engine 110, or its functions, may evaluate the image for its quality and properties using a static model. In some embodiments, the Image Analysis Processing Engine 110, or its functions, is configured to evaluate a pre-service image (i.e., an image of a tooth or quadrant prior to a service being performed) and a post-service image (e.g., post-treatment image) to determine a tooth or quadrant of change. The Image Analysis Processing Engine 110, or its functions, in some embodiments, is configured to determine, for certain procedures, a service type or service code associated with a service that is performed on the serviced tooth or quadrant. The Image Analysis Processing Engine 110, or its functions, in some embodiments, is configured to search the images or image files against a database of previously submitted images to determine duplications. Various image analysis functions may be employed, including converting the images to an intermediary data object, e.g., a hash, to perform the comparison. The various image analysis operations may include analysis functions that employ transactional/processing rules as well as machine learning and/or neural networks.

As noted above, the Image Analysis Processing Engine 110 may utilize one or more AI/ML engines/models in order to evaluate the medical claim images (and corresponding claim requests) and generate a score associated with each of one or more of the validation criteria. Each score may be generated through an ML/AI algorithm trained on the historical claims, associated images, and payers' historical approval or rejection history, as described herein. For the training, the one or more AI/ML engine(s) associated with the Image Analysis Processing Engine 110 may receive, e.g., for a given procedural code, attachments, and the corresponding diagnostic output from the analytical pipeline for a given claim request as inputs along with a payer approval status of that claim request and its associated electronic remittance advice (ERA) that provides an explanation from the health plan to a provider about a claim payment. The one or more AI/ML engine(s) associated with the image analysis engine can then learn the correlation between the diagnostic output and the payer approval status for a given procedural code. During run-time operation (after the AI engine has been trained), the Image Analysis Processing Engine 110 can then be used to generate a score associated with each of the above validation criteria based on how confident the AI engine/model is that the claim request and corresponding medical claim image satisfy the corresponding validation criteria. As discussed in more detail below in relation to the Transaction Rule Engine 112, the individual scores associated with each validation criteria may be combined in order to generate one or more overall scores associated with the claim, e.g., for the likelihood that a given payer will pay the claim based on the corresponding medical claim image attachment provided.

In some examples, the Image Analysis Processing Engine 110 is configured to generate a quality metric directed to a probability, determined by an AI/ML model/engine or business rule, that the image is of sufficient quality per the payer's historical acceptance of prior images associated with a healthcare claim or a healthcare claim of this procedural code.

In some examples, the Image Analysis Processing Engine 110 is configured to generate a type identifier directed to a probability, determined by an AI/ML model/engine or business rule, that the image is of an image type that matches or satisfies that type of code in the claim per the payer's historical acceptance of image types associated with a healthcare claim or a healthcare claim of this procedural code.

In some examples, the Image Analysis Processing Engine 110 is configured to generate a duplicate metric directed to a probability, determined by an AI/ML model/engine or business rule, that the image file is (or is not) a duplicate of that in another claim (e.g., a prior claim) per the payer's historical acceptance of prior images associated with a healthcare claim or a healthcare claim of this procedural code. Determination of duplication may be a multi-step process to better determine duplication (or not). For example, a first image analysis comparison of the one or more medical image files may be performed in a first orientation to images of the database; and a second image analysis comparison of the one or more medical image files may be performed in a second orientation to the images of the database. Additional orientation comparisons may be performed as desired.

Embodiments of an AI/ML model/engine may include a multi-layer neural network and/or a content similarity engine, which includes a natural language processor. It will be understood that other types of artificial intelligence systems can be used in other embodiments of the artificial intelligence engine, including, but not limited to, machine learning systems, deep learning systems, and/or computer vision systems. Examples of machine learning systems include those that may employ random forest regression, decision tree classifiers, gradient boost decision tree, support vector machines, AdaBoost, among others.

It will be appreciated that the concepts disclosed herein may be implemented using any types of natural language and/or machine learning models configured for classifying data such as characteristics of an image. For example, as various types of models are implemented, the models may be identified as more accurate in classifying data or images having specific characteristics in comparison to other models. In this regard, various models may be utilized according to example embodiments, and respective lists may be maintained listing the types of classifications that are accurately generated by the particular model. Accordingly, embodiments disclosed herein may be modified to incorporate any number of and types of natural language and/or machine learning models.

Returning again to FIG. 1D, following the validation/review operation, the Transaction Rule Engine 112 is configured to generate at least one score, e.g., corresponding to a likelihood the claim would be paid by the payer, based on the probabilities/scores associated with each of the above-referenced validation criteria (e.g., associated with first score (or set), second score (or set), third score (or set), fourth score (or set), etc.) as determined by the AI/ML engine(s) associated with the Image Analysis Processing Engine 110.

In alternative examples, the system is configured to compare the one or more scores (e.g., first score (or set), second score (or set), third score (or set), fourth score (or set), etc.) to those in a decision matrix, wherein the decision matrix includes a set of threshold values for a given category, and wherein the system is configured to generate an outcome based on a respective score being matched to the threshold values for the given category.

Returning to the example shown in FIG. 1D, the Attachment Advisor System 118 is configured to look up the payer threshold value(s) for a payer, or for a set of procedures of a given claim request established for that payer, (e.g., in the form of a decision matrix, discussed in more detail below) (from payer-specific rules) and compare the determined claim score(s) to the retrieved threshold value(s). For example, in one embodiment, if the claim score exceeds the payer threshold value (i.e., indicating a high probability that the payer would approve the claim based on the attached medical claim image), the Attachment Advisor System 118 can recommend approval of the claim and send the claim indicating the recommended approval (e.g., in the PWK (paperwork) segment or NTE segment (narrative field) of the claim), and with or without the corresponding medical claim image, to the payer 102 to remit payment to the service provider 104. By transmitting the claim with the recommended approval, and with or without the corresponding medical claim image attachment, the payer is able to process the claim automatically and avoid the manual review process that is required when it receives a medical claim image.

Alternatively, if the payer threshold value is higher than the claim score, the Attachment Advisor System 118 may perform one of several disapproval actions that may be selectable by the payer 102 associated with the claim or configured for the payer. In some embodiments, when the payer threshold value is higher than the claim score, the Attachment Advisor System 118 may be configured to relay the claim with the medical claim image attachment to the payer 102 for its review and adjudication. The claim must then be reviewed through a manual process by the payer 102. The relayed claim may include an indication that the claim was evaluated by the Attachment Advisor System 118. The claim request or its one or more attachments 120 or both may be returned by the payer 102 to the provider 104 for review, revision, and re-submission. A claim 120 returned to a provider 104 may include a communication describing a reason for its return.

At the payer's system, once the claim is with the payer, the payer's system can check, e.g., in the PWK segment or the NTE segment of the claim, to determine if the recommended approval by the Attachment Advisor Service 100 was provided. If there is no recommended approval by the Attachment Advisor Service 100 on the claim, the payer 102 can then review the claim through its standard process (including verifying the correctness of the attachment).

Because certain procedure codes are more common than other codes, the Attachment Advisor Service 100 can be configured to handle a large number of common claims on behalf of the payer 102.

The attachment advisor service 100, in some instances, may be configured to process the most common claim submissions. By processing the most common types of claims, the Attachment Advisor Service 100 can provide a high-value solution to payers (e.g., 102a, 102b) in addressing a substantial portion of the submitted claims. In doing so, the Attachment Advisor Service 100 can free resources (e.g., evaluators of the payer) that would otherwise be employed in the evaluation of such claims to focus on more complex or non-standard claims. For example, in addressing the most common claims for dental services—e.g., fillings, root canal therapy (procedure codes 03300-03330), crown restoration (procedure codes 02700-02899), other restorations such as filling and recement crowns (procedure codes 02900-02950), and extractions (procedure codes 07200-07250)—the Attachment Advisor Service 100 can address a substantial portion of the volume of claims (in this example) that the payer would otherwise have to process, leaving only the more difficult cases to be evaluated by the standard review process.

As noted above, the approved/recommended claim request 116 can be sent to the payer 102 without the one or more medical image files having to be reviewed (e.g., by manual review process) by the payer 102. The medical image files can be sent with the claim, not at all, or they may be retrievable from data store 123, but with the indication of the recommended approval, so that the payer may still avoid the manual review process ordinarily performed whenever it receives a claim with a medical claim image as an attachment. Also, advantageously, the payer 102 may not have to process and store the medical claim image if the claim does not include the image(s).

In the example shown in FIG. 1D, the Attachment Advisor Service 100 is shown to augment or supplement the claim reviewing process 128 (shown as “Claim Review” department 128) and claim adjudication process 129 (shown as “Adjudication” department 129) performed by claim reviewers and adjudicators employed by the payer 102. In a typical workflow (shown as 131) for the payer 102, the payer 102 first determines (130) if a received claim includes images (e.g., 124). If there are no images, then payer 102 evaluates (132) if the claim is clean and provides (134) the claim request (e.g., 122) to the adjudicators 136 (shown as “Adjudicate” 136) who can review the claim against a patient's policy and the number of permitted claims in order to approve (138) and/or reject (140) the claim. In this example, the rejection 140 can include a request for additional information or a rejection. If the evaluation 130 determines the claim (e.g., 120) includes images (142), then the claim is evaluated through a manual review process (144). The manual review process may involve having the images evaluated by a dental claim specialist (for a dental policy payer) (or a medical specialist and/or radiologist for a health insurance policy payer) for claim validity and consistency with the provided claim (e.g., 122). If approved, the approvals may be provided to the payment department 127 to provide remittance for the claim.

In some embodiments, the ingress module 116 is configured with APIs 145 configured to receive and retrieve claims from third-party services 146, rather than directly from providers 104. In this way, embodiments disclosed herein can work cooperatively with any form and/or ownership of clearinghouse 106.

While not shown in FIG. 1D, in another example embodiment, the Attachment Advisor Service 100 configured with an analytics and artificial intelligence engine to evaluate a healthcare claim in accordance with an illustrative embodiment may reside within the payer system 102.

### Example Method of Operation

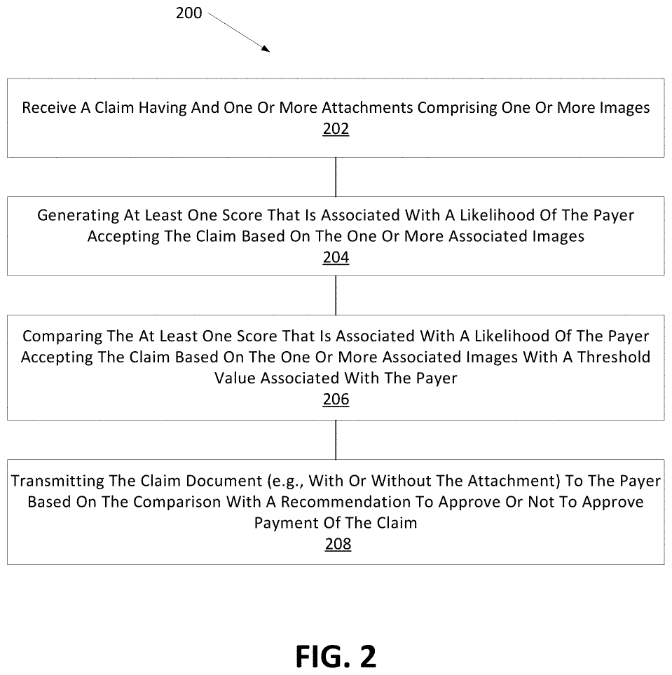

FIG. 2 shows a method 200 of operating the Attachment Advisor Service 100 in accordance with an illustrative embodiment. The method 200 includes receiving (202), by the attachment advisor service 100, a healthcare claim. Typically, the claim comprises a written portion and one or more associated images as attachments. In some instances, the healthcare claim may also include metadata descriptions either in lieu of or accompanying the attachments. The method 200 then includes generating (204) at least one score that is associated with a likelihood of the payer accepting the claim based on the one or more associated images and/or metadata descriptions.

In some instances, the at least one score comprises a score associated with image quality, image type, image duplication, image matching to claim, and the like. In some instances, the at least one score associated with image quality, image type, image duplication, image matching to the claim, and the like comprises a plurality of scores (e.g., a first score set). The first score set may be associated with a quality metric associated with the one or more medical image files (e.g., a correct-quality-metric score). The first score set may include a type identifier associated with the one or more medical image files (e.g., a correct-type-identification score). The first score set may include a duplicate metric of the one or more images file being a duplicate (e.g., duplication score). The first score set may include a claim match assessment associated with the one or more medical image files (e.g., a match-claim-to-image score). It is to be appreciated that the first score set may comprise a singular score comprised of any one of the correct-quality-metric score, the correct-type-identification score, the duplication score, or the match-claim-to-image score; or the first score set may comprise any combination or all of the correct-quality-metric score, the correct-type-identification score, the duplication score, and/or the match-claim-to-image score.

In some examples, the first score set includes a set of separate scores for each of the assessments. In some examples, the scores of any combination or all of the assessments are combined to provide a single score (e.g., by ensembling). Each of the separate scores may be determined by a corresponding AI/ML model/engine, as described herein. In some examples, the quality metric is directed to a probability, determined by an AI/ML model/engine or business rule, that the image is of sufficient quality per the payer's historical acceptance of prior images associated with a healthcare claim or a healthcare claim of this procedural code.

In some examples, the type identifier is directed to a probability, determined by an AI/ML model/engine or business rule, that the image is of an image type that matches that type of code in the claim per the payer's historical acceptance of image types associated with a healthcare claim or a healthcare claim of this procedural code.

In some examples, the duplicate metric is directed to a probability, determined by an AI/ML model/engine or business rule, that the image file is not a duplicate of that in another claim (e.g., a prior claim) per the payer's historical acceptance of prior images associated with a healthcare claim or a healthcare claim of this procedural code.

In some examples, the claim match assessment is directed to a probability, determined by an AI/ML model/engine or business rule, a tooth or a procedure identified of interest by the AI model, in the one or more image files, is the same as the tooth/procedure identified in the claim document per the payer's historical acceptance of prior images associated with a healthcare claim or a healthcare claim of this procedural code. For example, this process may comprise determining a first procedure code based on a natural-language processing analysis of the healthcare claim; determining a tooth number or quadrant and an associated procedure performed for a tooth associated with the tooth number or quadrant from the one or more image files using an image analysis of the one or more image files; determining a second procedure code for the determined tooth number based on and the determined associated procedure based on the determination using the image analysis of the one or more image files; comparing the first procedure code and the second procedure code; and determining the likely approval of the processing of the healthcare claim based on the comparison. In some instances, determination of the second procedure code may be performed in an analysis pipeline comprising an image type validation operation; a duplicate or manipulated image detection operation; a procedural level attachment validation operation; and/or a medical necessity check operation. Similar operations may be performed on the metadata description that may accompany a claim. Such a metadata processing operation may comprise determining, for a dental claim, from the metadata description, a tooth number or quadrant and an associated procedure performed for a tooth associated with the tooth number; determining from provided claim evidence comprising the one or more image files, an estimated tooth number, and an estimated procedure performed for a tooth via an image analysis of the one or more image files; and comparing (i) the tooth number and associated procedure from the metadata description to the (ii) the estimated tooth number and associated procedure from the provided claim evidence to generate a score of the claim.

In some examples, the Attachment Advisor Service 100 may further perform a viability check operation comprising, determining for a dental healthcare claim an FMX image type or a bitewing image type of the one or more image files; determining a third procedure code in the healthcare claim for the one or more services performed; and determining an action to be taken on the healthcare claim based on a rule determined for the third procedure code in view of the FMX image type or the bitewing image type determination.

In some instances, the at least one score comprises a score or scores associated with medical necessity (e.g., a second score or second score set) using the one or more image files. The second score (or score set) is associated with a probability, determined by an AI/ML model/engine or business rule, that the one or more image files shows a medical condition to satisfy the need to perform the procedure.

In some instances, the at least one score comprises a score or scores associated with natural language processing (e.g., a third score or third score set). The third score (or score set) is associated with a probability, determined by an AI/ML model/engine or business rule, that the claim document includes a narrative that matches an assessment of the one or more image files.

In some examples, the Attachment Advisor Service 100 is configured to generate the at least one score by performing a combination of one or more image analysis engines and/or one or more multiple AI/ML processing engines.

The method 200 then includes comparing (206) the at least one score to a threshold value. The threshold value may be established by the payer, or it may be established for the payer by reviewing historical claims and how they were processed by the payer. In some examples, the Attachment Advisor Service 100 is configured to compare one or more scores (e.g., first score (or set), second score (or set), third score (or set), fourth score (or set), etc.) to those in a decision matrix, later discussed in further detail herein, wherein the decision matrix includes a set of threshold values for a given category, and wherein the system is configured to generate an outcome based on a respective score being matched to the threshold values for the given category.

The method 200 then includes transmitting (208) the claim document (e.g., with or without the attachment) to the payer. In some examples, the claim document includes a recommendation to approve remittance of the claim document upon the system determining at least one score exceeds a corresponding threshold value or, in some instances, a recommendation to not approve remittance of the claim document upon the system determining at least one score exceeds a corresponding threshold value. In some examples, the system is configured to transmit the recommendation and claim document with the payer knowing that the claim would not have to be reviewed through a manual review process. In some examples, the system is configured to send the claim document and the one or more image files without an approval indicator to the payer for the payer to evaluate the document and the one or more image files through a manual review process, upon the system determining that at least one score does not exceed a corresponding threshold value.

### Example Attachment Advisor Processing Engine

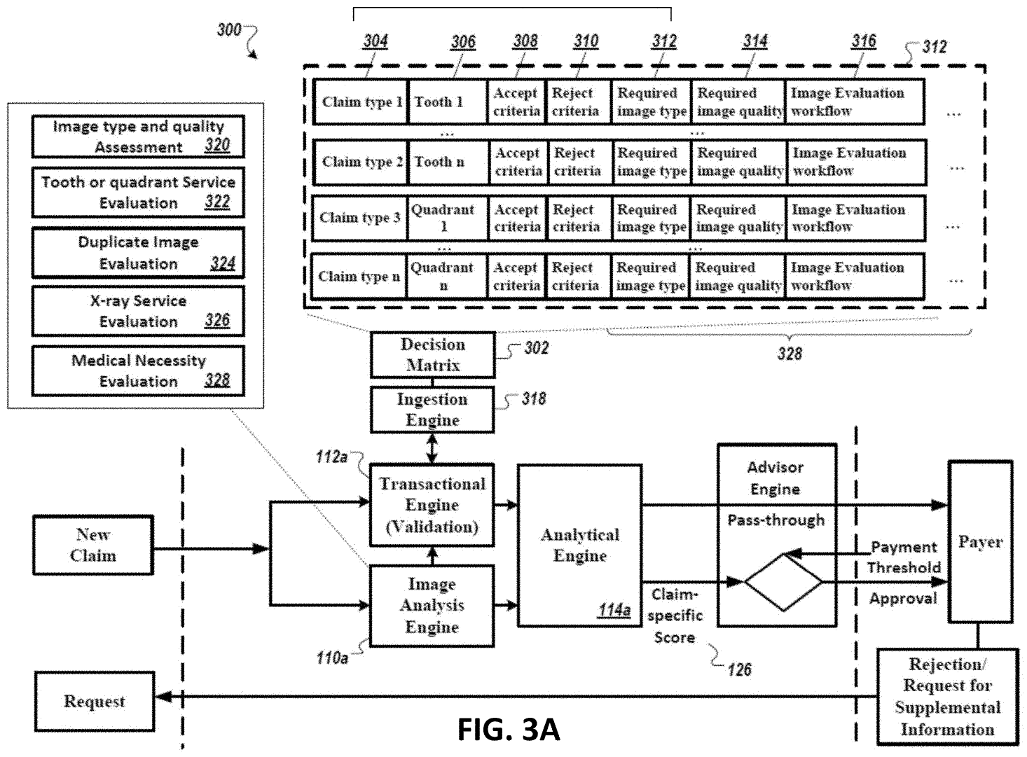

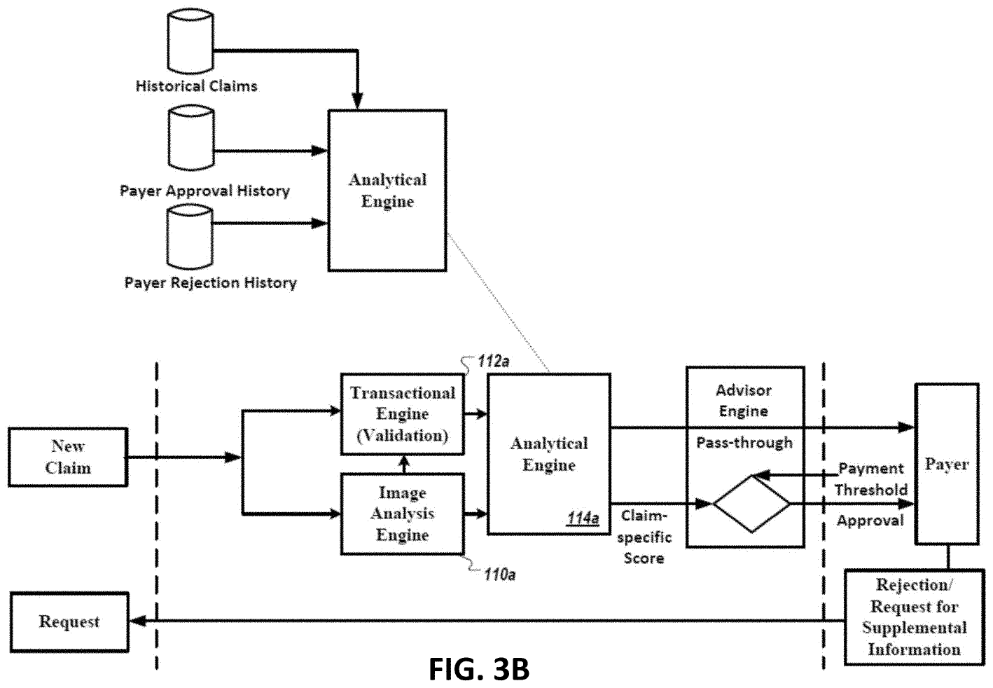

FIGS. 3A and 3B show an example Attachment Advisor Processing Engine 108 and Attachment Advisor System 118 (collectively referred to as Attachment Advisor Engine, now shown as 300) in accordance with an illustrative embodiment. The Attachment Advisor Engine 300 includes the Image Analysis Processing Engine 110 (shown as 110a) and the transactional engine 112 (shown as 112a).

The Image Analysis Processing Engine 110, which comprises a portion of the Attachment Advisor Processing Engine (see FIG. 1D), may include a plurality of functions (shown as “Image Type and Quality Assessment” 320, “Tooth or Quadrant Service Evaluation” 322, “Duplicate Image Evaluation” 324, “X-ray Service Evaluation” 326, and “Medical Necessity Evaluation” 328) which are configured in some embodiments in an image processing pipeline, comprising AI/ML model/engines or processing rules, to evaluate the image for its quality and properties, to evaluate the service performed on a tooth or mouth quadrant, and/or search the images against a database for duplication. In some embodiments, these services are configured to provide an estimated diagnosis of the patient to which the estimation can be employed to compare to the claim.

Image Type and Quality Assessment (320a). The Image Analysis Processing Engine 110 of one embodiment can evaluate each submitted image to classify it according to a set of defined image formats or a likelihood, determined by an AI/ML model/engine or business rule, that the submitted images matches that which the payer has historically accepted for a given healthcare claim or a healthcare claim of a given procedural code. Examples of classified image types or image that can be assessed include but are not limited to panoramic film, full mouth series, periapical, bitewings, occlusal, CBCT (Cone-beam computed tomography systems), periodontal charts, intraoral Image, partial count, cephalometric images, and radiographic images. The Image Analysis Processing Engine 110 can determine the image size and resolution. The Image Analysis Processing Engine 110 can also evaluate documents to classify them as narratives, explanation of benefits, verification, referral form, diagnosis, reports, progress notes.

Tooth or Quadrant Service Evaluation (322a). The Image Analysis Processing Engine 110 can evaluate and label a pre-service image or a post-service image with tooth numbers. The Image Analysis Processing Engine 110 can evaluate a pre-service image and a post-service image to generate a difference image between them and apply the determined labels to the difference image. The difference image may indicate the presence of a crown and/or a cavity/filling.

In some embodiments, the Image Analysis Processing Engine 110 is provided (i) a procedure code and (ii) a tooth number or quadrant number as extracted from a NPL operation of the claim request. The Image Analysis Processing Engine 110 can retrieve an image analysis function and settings associated with the procedural code provided. For example, for a procedural code associated with a filling or a crown, the Image Analysis Processing Engine 110 can evaluate a specific tooth to determine if there is a pixel-by-pixel difference in the tooth between a pre-service image and a post-service image. The analysis may normalize the size of the tooth for the comparison.

In some embodiments, the Image Analysis Processing Engine 110 is configured to determine a probability, determined by an AI/ML model/engine or business rule, a tooth or a procedure identified of interest by the AI model, in the one or more image files is the same as the tooth/procedure identified in the claim document per the payer's historical acceptance of prior images associated with a healthcare claim or a healthcare claim of this procedural code.

Duplicate Image Evaluation (324a). The duplicate image evaluation module is configured to perform a pixel-by-pixel comparison of the provided image to previously submitted images in a database. In some examples, the Image Analysis Processing Engine 110 is configured to determine a probability, determined by an AI/ML model/engine or business rule, that the image file is not a duplicate of that in another claim (e.g., a prior claim) per the payer's historical acceptance of prior images associated with a healthcare claim or a healthcare claim of this procedural code.

The transactional engine 112, which comprises a portion of the Attachment Advisor System 118 (see FIG. 1D), is configured to execute business rules for the payer using, in some embodiments, a decision matrix. In the example of FIG. 3A, the decision matrix 302 includes a plurality of rows in which each row includes criteria for an evaluation of a given procedural code and tooth/quadrant. In the example shown in FIG. 3A, the decision matrix 302 includes a claim type field 304, a tooth or quadrant position field 306, an accept criteria field 308, a reject criteria field 310, a required image type field 312, a required image quality field 314, and an image evaluation workflow field 316. The claim type field 304 and tooth or quadrant position field 306 can be used in an executing program to determine the one or more business rules to execute for a given claim. The business rule logic may evaluate the accept criteria and the reject criteria in fields 308 and 310 to determine the condition for approval and/or rejection. In some embodiments, the accept criteria and the reject criteria fields 308, 310 may list identifiers of columns in the decision matrix associated with an assessment, e.g., required image type field 312, required image quality field 314, image evaluation workflow field 316.

In the example shown in FIG. 3A, the decision matrix 302 is implemented to operate with an ingestion engine 318. The ingestion engine 318 can parse through the criteria (e.g., setpoints) in the decision matrix 302 to populate a decision tree that is enforced in the transactional engine 112a. The decision matrix 302 may be a spreadsheet, in some embodiments, that is used to generate a comma-delimited file that is ingested by the ingestion engine 318. The ingestion operation and global decision matrix 302 facilitate the rapid update of payer's rule for claim review by the Attachment Advisor System 118 without business rules of the Attachment Advisor System 118 having to be manually updated with each payer's update.

In some embodiments, the elements in the specific “accept” criteria and “reject” criteria fields may be parsed by an executing program of the ingestion engine 318 to determine the column to perform an evaluation. In other embodiments, the accept criteria and the reject criteria fields 314, 316 may be implemented in the executing program. The criteria fields 324 may set out different functions or conditions to be evaluated for a given claim type (e.g., field 310) and/or tooth or quadrant position (e.g., field 312).

For example, for a claim directed to a filling treatment of a patient, a payer may require a certain x-ray image prior to and after the procedure. The payer may also require certain requirements for the submitted x-ray image and a certain set of validation operations to be performed. The decision matrix 302 may include a set of rows, where each row includes a procedure code for the filling procedure and a designated tooth number. Each row may indicate x-ray, panoramic film, or full mouth series as a required image (e.g., in field 312). The image evaluation workflow (field 316) may list an image analysis function to evaluate for image type and quality (e.g., function 320), tooth service evaluation (e.g., function 322), and a duplicate image evaluation (e.g., function 324), an x-ray service evaluation 326, and a medical necessity evaluation 328.

The rules for adjudication and attachment verification can vary from payer to payer. The ingestion engine 318 also facilitate the use of different decision matrices 302 in which the decision matrix 302 can employ specific payer rules for a given payer (e.g., 102).

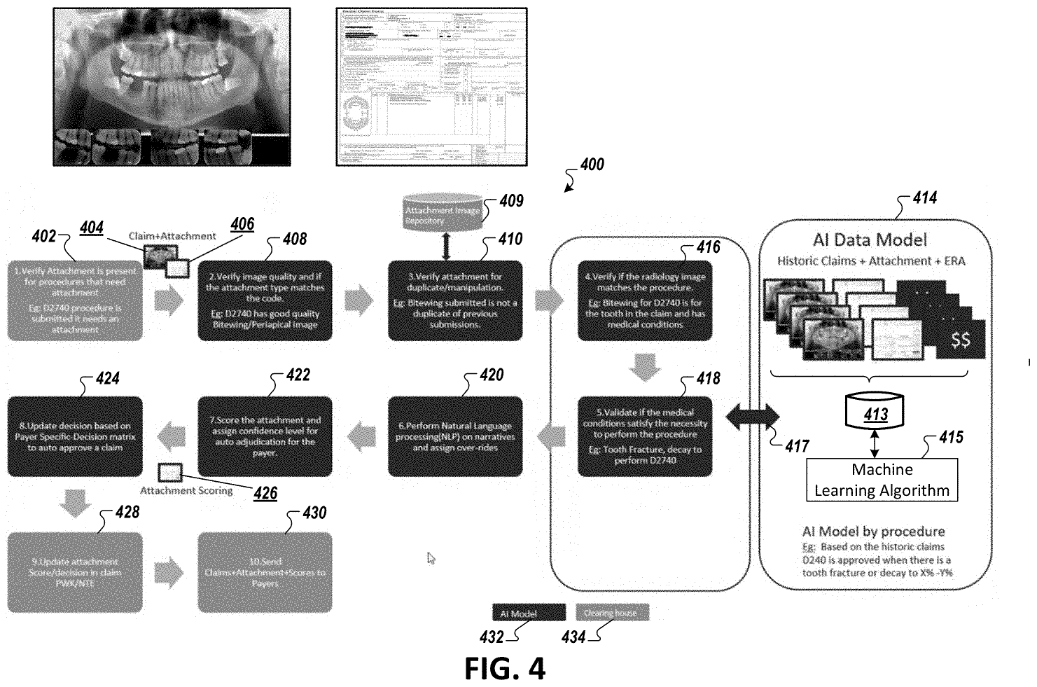

FIG. 4 shows an example image processing pipeline and workflow 400 of the Attachment Advisor Service 100 working cooperatively with a clearinghouse 106 in accordance with an illustrative embodiment. The order of the operations may change.

In the example shown in FIG. 4, the pipeline 400 receives a claim and verifies (402), by the clearinghouse 106, that an image file 404 (previously shown as 124) is present as an attachment of the claim 406 (previously shown as 122) and is executed upon by a set of modules (comprised of a combination of AI/ML engines/models and business rules) to (i) check for duplicate claim submissions, (ii) validate that the submitted medical claim images match the required image for the submission, and (iii) validate that the tooth to which a service was performed and the service performed, both as evident in the submitted images, is consistent with the information in the claim request, and/or (iv) confirm the medical condition satisfies the necessity for the procedure. The process may further include generating a probability score associated with each of the above validation criteria based on how confident the AI/ML engine/model is that the claim request and/or the corresponding medical claim image satisfy the corresponding validation criteria (e.g., 90% confident the image is of sufficient quality). The outputs of the modules pipeline (i.e., the validation scores) are compared to criteria in the decision matrix (e.g., 302) to determine the likelihood of approval of the claim or the need of the claim for manual review (e.g., by the payer 102). In the example shown in FIG. 4, the two parallel processes are shown performed by two entities: (i) the transactional engine 112a and (ii) the image and analytical engine 110a.

In FIG. 4, at operation 402, a transaction engine 112a associated with the clearinghouse (shown as 434) can first assess a claim via natural language processing and optical character recognition operation of a claim and compare a procedure number (e.g., D2740) to a database to determine that the claim requires an attachment.

The pipeline 400 then performs (408) image verification via the Image Analysis Processing Engine 110a of the Attachment Advisor Service (shown as 432) to verify the image quality (i.e., determine a probability that the quality of the image is sufficient to be approved by the payer) and determine a probability that the attachment type matches the procedure code. In some embodiments, the Image Analysis Processing Engine 110a of the Attachment Advisor Service 432 employs a machine learning algorithm as described below.

The pipeline 400 then performs (410) image verification via the Image Analysis Processing Engine 110a of the Attachment Advisor Service 432 to verify the attachment as not being a duplicate or manipulation. In the example, an example verification may include determining a probability that a bitewing radiograph that is submitted is not a duplicate or a previous submission. The image verification operation (410) may be performed against an attachment image repository 409.

The pipeline 400 then triggers the operation of a machine-learning-based clinical claim evaluation of the images (404) employing an AI data model (414) of the Attachment Advisor Service 432 (e.g., implementing functions 322, 326, and 328 to verify (416) (and, more specifically, to determine a probability)) that the attachment images 404 match the procedure listed in the claim 406. In particular, the AI data model 414, in some embodiments, includes a machine learning algorithm 415 that is generated from a set of historical claims, attachments, and electronic remittance advice (ERA) that is trained in conjunction with clinical parameters by procedure codes (shown stored in data store 413). The AI data model 414 can output a clinical estimation (417) of a procedure that is desired for a patient based on the provided attachment images 404.

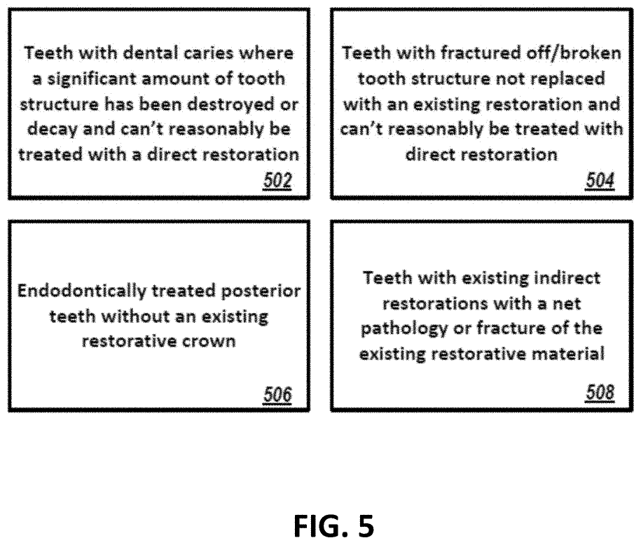

A non-exhaustive list of examples of clinical estimations (e.g., output 417) that may be generated by the AI-data model 414 are provided in FIG. 5. The clinical estimation facilitates the automated clinical review to provide validation and verification of claims to which the Attachment Advisor Processing Engine 108 can provide an approval to the payer 102. Claims and procedural code that cannot be processed fully by the Attachment Advisor Processing Engine 108 are forwarded to the payer 102 for their standard manual review. To this end, any number of automated clinical review would have utility in reducing the cost of the clinical review process and improving approval time for the payer 102 among other benefits described herein.

In the example shown in FIG. 5, four examples of clinical estimation output of the AI data model 414 are shown. The first example (502) includes a determination or evaluation of teeth (e.g., in image 404) with dental caries having a significant amount of tooth structure being destroyed or decay and can't reasonably be treated with a direct restoration. The determination may be based on a machine-learning algorithm.

The second example (504) includes a determination or evaluation of teeth (e.g., in image 404) having a fractured off/broken tooth structure not replaced with an existing restoration and can't reasonably be treated with direct restoration.

The third example (506) includes a determination or evaluation of teeth (e.g., in image 404) having endodontically treated posterior teeth without an existing restorative crown.

The fourth example (508) includes a determination or evaluation of teeth with existing indirect restorations with a net pathology or fracture of an existing restorative material.

Each of the four examples (502, 504, 506, 508) can be determined via an algorithm that can first isolate a tooth, e.g., within an x-ray image (e.g., image 404) via segmentation operation, and employ a trained neural network (e.g., a convolutional neural network) having been trained with training data that correlates the segmented image (e.g., x-ray image) of a given tooth with prior clinical diagnostics of the same condition. The output may be an clinical code corresponding to a given clinical diagnosis as determined by the trained neural network. The clinical code can then be compared to a set of predefined procedure codes associated with treatments that may be performed for that clinical code (e.g., via operation 418). One or more AI-data models can be configured for the different types of medical images such as panoramic film, full mouth series, periapical, bitewings, occlusal, CBCT (Cone-beam computed tomography systems), periodontal charts, intraoral Image, partial count, cephalometric images, radiographic images, and other image types as described herein.

Based on the machine-learning-based clinical claim evaluation (414), the pipeline 400 then verifies (416) (or, more specifically, determines a probability) that the attachment images 404 match the procedure listed in the claim 406 using the output 417 from the AI data model 414 comprising the clinical estimation of a procedure.

The pipeline 400 then validates (418) if the medical condition was necessary by comparing the output 417 to list of procedure codes associated with procedures that could be performed in view of a clinical estimation, and generates yet another score associated with this validation criteria.

The pipeline 400 may then evaluate (420) whether there are overriding narratives from the claim 406 that override the medical evaluation. For example, the doctor's notes or annotations may include reasons for certain procedures and operations. The evaluation can determine the existence of these doctor notes or annotations via natural language processing to determine if the notes or annotations are directed to the procedure code in the claims 406. Doctor's notes and annotation can be given higher priority with respect to a claim approval. In some embodiments, inconsistencies between the doctor's notes and annotation and the output of the clinical analysis may flag the claim for manual processing or audit (e.g., by the payer 102 or by system administrator of system 100).

The pipeline 400 then generates at least one score (422) associated with the attachment and claim based on the individual scores/probabilities associated with the preceding validation and verification steps (408, 410, 426, 418 and 420), wherein the at least one score is associated with a confidence level for auto adjudication by the payer (shown as “Attachment Scoring” 426). The pipeline 400 may compare the score(s) 426 to a payer-provided threshold value(s) included in the decision matrix described above.

The transaction engine 112a associated with the clearinghouse 434 can then update (428) the attachment (404) and claim 406) with the scoring (e.g., 426) and/or include an indication that the attachment and claim have been validated and it is recommended that the claim be approved via the automated system for payment.

The transaction engine 112a associated with the clearinghouse 434 can then send (430) the approval recommendation to the payer 102. In some embodiments, the approval may include the claim 406), attachment (404), scoring (426). As noted above, in one embodiment, where the score(s) (426) each exceed threshold value(s) defined by a payer within the decision matrix, the claim 406) may be sent to the payer with an indication of the recommended approval, but without the corresponding medical claim image, so that the payer can avoid the manual review process triggered by receipt of a medical claim image. In some embodiments, the approval recommendation may include a claim processing engine transaction number, e.g., in the PWK segment of the claim or an NTE segment, e.g., based on the payer's requirements.

### Computing Environment

FIG. 6 shows an example computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, cloud-based systems, microprocessor-based systems, network personal computers (PCs), minicomputers, mainframe computers, embedded systems, distributed computing environments that include any of the above systems or devices, and the like. The computing environment may include a cloud-based computing environment.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an example system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

The computing system 600 described herein may comprise all or part of an artificial neural network (ANN). An ANN is a computing system including a plurality of interconnected neurons (e.g., also referred to as “nodes”). This disclosure contemplates that the nodes can be implemented using a computing device (e.g., a processing unit and memory as described herein), such as computing device 600 described herein. The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan H, or rectified linear unit (ReLU) function), and provide an output in accordance with the activation function. Additionally, each node is associated with a respective weight. ANNs are trained with a dataset to maximize or minimize an objective function (e.g., the business goals and objectives). In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine-learning model. This disclosure contemplates that the machine-learning model can be any supervised learning model, semi-supervised learning model, or unsupervised learning model. Optionally, the machine-learning model is a deep learning model. Machine-learning models are known in the art and are therefore not described in further detail herein.

A convolutional neural network (CNN) is a type of deep neural network that can be applied, for example, to non-linear workflow prediction applications, such as those described herein. Unlike a traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other supervised learning models that may be utilized according to embodiments described herein include a logistic regression (LR) classifier, a Naïve Bayes' (NB) classifier, a k-NN classifier, a majority voting ensemble, and the like.

A LR classifier is a supervised classification model that uses the logistic function to predict the probability of a target, which can be used for classification. LR classifiers are trained with a data set (also referred to herein as a “dataset”) to maximize or minimize an objective function, for example a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A NB classifier is a supervised classification model that is based on Bayes' Theorem, which assumes independence among features (i.e., presence of one feature in a class is unrelated to presence of any other features). NB classifiers are trained with a data set by computing the conditional probability distribution of each feature given label and applying Bayes' Theorem to compute conditional probability distribution of a label given an observation. NB classifiers are known in the art and are therefore not described in further detail herein.

A k-NN classifier is a supervised classification model that classifies new data points based on similarity measures (e.g., distance functions). k-NN classifiers are trained with a data set (also referred to herein as a “dataset”) to maximize or minimize an objective function, for example a measure of the k-NN classifier's performance, during training. This disclosure contemplates that any algorithm that finds the maximum or minimum of the objective function can be used. k-NN classifiers are known in the art and are therefore not described in further detail herein.

A majority voting ensemble is a meta-classifier that combines a plurality of machine-learning classifiers for classification via majority voting. In other words, the majority voting ensemble's final prediction (e.g., class label) is the one predicted most frequently by the member classification models. Majority voting ensembles are known in the art and are therefore not described in further detail herein.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for evaluating a healthcare claim comprising:
at least one computing device comprising a processor and a memory, said memory having instructions stored thereon that when executed by the processor cause the at least one computing device to perform a plurality of operations, wherein the plurality of operations include:
receiving, by the processor, a healthcare claim for a healthcare service performed by a healthcare service provider, the healthcare claim comprising (i) a claim request listing one or more services provided by the healthcare service provider for a patient and (ii) one or more image files, and/or metadata descriptions thereof, corresponding to the one or more services;
determining, by the processor, at least one score indicating a likelihood of approval of the healthcare claim by a payer based on an analysis of the one or more image files and/or the metadata descriptions thereof;
comparing, by the processor, the determined at least one score to a threshold value associated with the payer to create a recommendation, wherein if the at least one score is equal to or greater than the threshold value, then the recommendation is to approve the healthcare claim for payment, and if the at least one score is less than the threshold value, then the recommendation is to not approve the healthcare claim for payment; and
transmitting at least a portion of the healthcare claim to the payer.

2. The system of claim 1, wherein the at least one score for the healthcare claim is determined by an AI/ML engine/model trained with past healthcare claims and decision history data of the payer associated with the past healthcare claims.

3. The system of claim 2, wherein the at least one score comprises a first score, said first score associated with a set of factors comprising quality, image type, duplication, and match of what's in the healthcare claim, wherein the first score is based on separate scores/probabilities for each of the set of factors as determined by individual respective AI/ML engines/models trained with past healthcare claims and decision history data of the payer associated with the past healthcare claims,
wherein the quality factor is determined by its respective AI/ML engine/model predicting a probability that the one or more image files of the healthcare claim are of sufficient quality,
wherein the image type factor is determined by its respective AI/ML engine/model predicting a probability that the one or more image files of the healthcare claim are of a specific types that match a procedural code in the claim request,
wherein the duplication factor is determined by its respective AI/ML engine/model predicting a probability that the one or more image files are or are not duplicate images from another healthcare claim,
wherein the match of what's in the healthcare claim factor is determined by its respective AI/ML engine/model predicting a probability, for a dental claim, that a tooth/procedure identified in the one or more image files and/or metadata description is a same tooth/procedure identified in the healthcare claim request.

4. The system of claim 3, wherein the at least one score comprises a plurality of scores, each of the plurality of scores is determined by a respective AI/ML engine/model trained with past healthcare claims and decision history data of the payer associated with the past healthcare claims, wherein the plurality of scores further comprise a second score and a third score, said second score associated with medical necessity, comprising a probability that a medical condition satisfies a need to perform a procedure included in the healthcare claim,
wherein said third score is associated with natural language processing of a narrative of the healthcare claim, comprising a probability that a procedure described in the narrative of the healthcare claim matches with the one or more image files, metadata description, and/or claim request of the healthcare claim,
wherein comparing, by the processor, the determined at least one score to a threshold value associated with the payer comprises comparing the first score, the second score and the third score to a plurality of threshold values associated with the payer that comprise a decision matrix and making the recommendation for the payer based on the comparison using the decision matrix.

5. The system of claim 1, wherein transmitting at least the portion of the healthcare claim to the payer comprises transmitting only the claim request to the payer, wherein the claim request is accompanied by the recommendation.

6. The system of claim 5, wherein the recommendation is the recommendation to approve payment of the healthcare claim.

7. The system of claim 5, wherein the claim request transmitted to the payer with the recommendation further comprises a link to the one or more image files.

8. The system of claim 1, wherein transmitting at least the portion of the healthcare claim to the payer comprises transmitting the claim request and the one or more image files, and/or metadata descriptions thereof to the payer without the recommendation.

9. A computer-implemented method for evaluating a healthcare claim comprising:
receiving, by a processor, a healthcare claim for a healthcare service performed by a healthcare service provider, the healthcare claim comprising (i) a claim request listing one or more services provided by the healthcare service provider for a patient and (ii) one or more image files, and/or metadata descriptions thereof, corresponding to the one or more services;
determining, by the processor, at least one score indicating a likelihood of approval of the healthcare claim by a payer based on an analysis of the one or more image files and/or the metadata descriptions thereof, wherein the at least one score for the healthcare claim is determined by an AI/ML engine/model trained with past healthcare claims and decision history data of the payer associated with the past healthcare claims;
comparing, by the processor, the determined at least one score to a threshold value associated with the payer to create a recommendation, wherein if the at least one score is equal to or greater than the threshold value, then the recommendation is to approve the healthcare claim for payment, and if the at least one score is less than the threshold value, then the recommendation is to not approve the healthcare claim for payment; and
transmitting at least a portion of the healthcare claim to the payer.

10. The method of claim 9, wherein the at least one score comprises a first score, said first score associated with a set of factors comprising quality, image type, duplication, and match of what's in the healthcare claim, wherein the first score is based on separate scores/probabilities for each of the set of factors, as determined by individual respective AI/ML engines/models trained with past healthcare claims and decision history data of the payer associated with the past healthcare claims,
wherein the quality factor is determined by its respective AI/ML engine/model predicting a probability that the one or more image files of the healthcare claim are of sufficient quality,
wherein the image type factor is determined by its respective AI/ML engine/model predicting a probability that the one or more image files of the healthcare claim are of a specific types that match a procedural code in the claim request,
wherein the duplication factor is determined by its respective AI/ML engine/model predicting a probability that the one or more image files are or are not duplicate images from another healthcare claim,
wherein the match of what's in the healthcare claim factor is determined by its respective AI/ML engine/model predicting a probability, for a dental claim, that a tooth/procedure identified in the one or more image files and/or metadata description is a same tooth/procedure identified in the healthcare claim request.

11. The method of claim 10, wherein the at least one score comprises a plurality of scores, each of the plurality of scores is determined by a respective AI/ML engine/model trained with past healthcare claims and decision history data of the payer associated with the past healthcare claims, wherein the plurality of scores further comprise a second score and a third score, said second score associated with medical necessity, comprising a probability that a medical condition satisfies a need to perform a procedure included in the healthcare claim,
wherein said third score is associated with natural language processing of a narrative of the healthcare claim, comprising a probability that a procedure described in the narrative of the healthcare claim matches with the one or more image files, metadata description, and/or claim request of the healthcare claim,
wherein comparing, by the processor, the determined at least one score to a threshold value associated with the payer comprises comparing the first score, the second score and the third score to a plurality of threshold values associated with the payer that comprise a decision matrix and making the recommendation for the payer based on the comparison using the decision matrix.

12. The method of claim 9, wherein transmitting at least the portion of the healthcare claim to the payer comprises transmitting only the claim request to the payer, wherein the claim request is accompanied by the recommendation.

13. The method of claim 12, wherein the recommendation is the recommendation to approve payment of the healthcare claim.

14. The method of claim 12, wherein the claim request transmitted to the payer with the recommendation further comprises a link to the one or more image files.

15. The method of claim 9, wherein transmitting at least the portion of the healthcare claim to the payer comprises transmitting the claim request and the one or more image files, and/or metadata descriptions thereof to the payer without the recommendation.

16. A non-transitory computer-readable medium having instructions stored thereon that when executed by at least one computing device cause the at least one computing device to perform a plurality of operations for evaluating a healthcare claim, wherein the plurality of operations include:
receiving, by a processor of the computing device, a healthcare claim for a healthcare service performed by a healthcare service provider, the healthcare claim comprising (i) a claim request listing one or more services provided by the healthcare service provider for a patient and (ii) one or more image files, and/or metadata descriptions thereof, corresponding to the one or more services;
determining, by the processor, at least one score indicating a likelihood of approval of the healthcare claim by a payer based on an analysis of the one or more image files and/or the metadata descriptions thereof, wherein the at least one score for the healthcare claim is determined by an AI/ML engine/model trained with past healthcare claims and decision history data of the payer associated with the past healthcare claims;
comparing, by the processor, the determined at least one score to a threshold value associated with the payer to create a recommendation, wherein if the at least one score is equal to or greater than the threshold value, then the recommendation is to approve the healthcare claim for payment, and if the at least one score is less than the threshold value, then the recommendation is to not approve the healthcare claim for payment; and
transmitting at least a portion of the healthcare claim to the payer.

17. The computer-readable medium of claim 16, wherein the at least one score comprises a plurality of scores, each of the plurality of scores is determined by a respective AI/ML engine/model trained with past healthcare claims and decision history data of the payer associated with the past healthcare claims, wherein the plurality of scores comprise a first score set, said first score set associated with a set of factors comprising quality, image type, duplication, and match of what's in the healthcare claim, wherein the first score is based on separate scores/probabilities for each of the first score set, as determined by individual respective AI/ML engines/models,
wherein the quality factor is determined by its respective AI/ML engine/model predicting a probability that the one or more image files of the healthcare claim are of sufficient quality,
wherein the image type factor is determined by its respective AI/ML engine/model predicting a probability that the one or more image files of the healthcare claim are of a specific types that match a procedural code in the claim request,
wherein the duplication factor is determined by its respective AI/ML engine/model predicting a probability that the one or more image files are or are not duplicate images from another healthcare claim,
wherein the match of what's in the healthcare claim factor is determined by its respective AI/ML engine/model predicting a probability, for a dental claim, that a tooth/procedure identified in the one or more image files and/or metadata description is a same tooth/procedure identified in the healthcare claim request,
wherein the plurality of scores further comprise a second score and a third score,
said second score associated with medical necessity, comprising a probability that a medical condition satisfies a need to perform a procedure included in the healthcare claim,
wherein said third score is associated with natural language processing of a narrative of the healthcare claim, comprising a probability that a procedure described in the narrative of the healthcare claim matches with the one or more image files, metadata description, and/or claim request of the healthcare claim,
wherein comparing, by the processor, the determined at least one score to a threshold value associated with the payer comprises comparing the first score, the second score and the third score to a plurality of threshold values associated with the payer that comprise a decision matrix and making the recommendation for the payer based on the comparison using the decision matrix.

18. The computer-readable medium of claim 16, wherein transmitting at least the portion of the healthcare claim to the payer comprises transmitting only the claim request to the payer, wherein the claim request is accompanied by the recommendation.

19. (canceled)

20. The computer-readable medium of claim 18, wherein the claim request transmitted to the payer with the recommendation further comprises a link to the one or more image files.

21. The computer-readable medium of claim 16, wherein transmitting at least the portion of the healthcare claim to the payer comprises transmitting the claim request and the one or more image files, and/or metadata descriptions thereof to the payer without the recommendation.
